(19) United States
(12) Patent Application Publication
(10) Pub. No.: US 2009/0027633 A1
(43) Pub. Date: Jan. 29, 2009

(54) Method of calibrating projection lens

(76) Inventors: Hao-Chang Tsao, Hsinchu (TW); Jen-Jia Chen, Hsinchu (TW)

Correspondence Address: NORTH AMERICA INTELLECTUAL PROPERTY CORPORATION, P.O. BOX 506, MERRIFIELD, VA, 22116, US

(21) Appl. No.: 12/034,641

(22) Filed: Feb. 20, 2008

(30) Foreign Application Priority Data
Jul. 23, 2007 (TW) 096126763

(51) Int. Cl. G03B 21/53

(52) U.S. Cl. 353/121

(57) ABSTRACT

A method of calibrating projection lens in a projector is disclosed herein. The method includes setting a coordinate matrix over a visible region of a projector, checking whether a coordinate of a mobile target of the projection lens is located within the visible region, and moving the projection lens to the coordinate of the mobile target when the coordinate of the mobile target is confirmed to be located within the visible region.

### BACKGROUND OF THE INVENTION

1. Field of the Invention

The present invention relates to a method of calibrating a projection lens, and more particularly, to a method of calibrating a projection lens by means of establishing a coordinate matrix corresponding to a visible region of a projector, checking whether a mobile target of the projection lens is located within the visible region by referencing the established coordinate matrix, and calibrating the projection lens according to a result of the checking step.

2. Description of the Prior Art

While using a conventional projector, besides the body of the projector being required to be well disposed, the projection lens of the projector is also required to be fine-tuned so as to precisely project images on ideal locations, such as on a curtain or on a whiteboard. Therefore, in a conventional projector, a location of a focus of the projection lens is fine-tuned by horizontal movements or vertical movements of the projection lens. As shown in FIG. 1, a conventional projector 100 includes a projection lens 102, which aims at an ideal projecting location with a center 104. Movements of both the projection lens and the center 104 are controlled by machines disposed inside the projector 100. As shown in FIG. 1, in one movement of the projection lens 102, a horizontal movement or a vertical movement is merely achieved with a built-in step motor, which is not illustrated herein, of the projector 100, a range of the one movement is also restricted by the mechanism of the projection lens 102 so that said range is bounded within a visible region 108, which is surrounded by dotted lines. In other words, when the range of movements of the projection lens 102 is beyond the visible region 108, images of the projector 100 cannot be formed in adequate projecting locations. As shown in FIG. 2, a range of movements of the center 104 is restricted by the visible region 108. Please refer to FIG. 3 and FIG. 4. In an ideal situation shown in FIG. 3, when the location of the center 104 is to be moved from a location A to a location B, the center 104 has to be moved from the location A to a location A′ in advance, and then be moved to the location B along edges of the visible region 108. However, in a practical situation shown in FIG. 4, since movements of the projection lens 102 are restricted by the mechanism, the projection lens 102 is merely moved horizontally or vertically. Therefore, a user has to move the center 104 from the location A to the location A′ vertically, move the center 104 from the location A′ to a location B′ horizontally, and move the center 104 from the location B′ to the location B vertically, with all manually. In FIG. 4, though the user merely takes three single step movements to move the center 104 from the location A to the location B, the user cannot successfully move the center 104 from the location A to the location B every time with subjective decisions. For example, in FIG. 4, after the user moves the center 104 from the location A to the location A′, the center 104 cannot be further moved upward and vertically since movements of the projection lens 102 are restricted by the visible region 108. However, if the user is not aware of such a situation and thinks that the center 104 reaches the height of the location B, the user may keep an erroneous location of the center 104 in mind so that the projecting location of the projection lens 102 is erroneous as well. As it can be observed from the above descriptions, when the user tries to adjust the projecting location of the projector 100 by adjusting the projection lens 102, an ideal projecting location of the projection lens 102 has to be approached with step horizontal movements and step vertical movements of the projection lens 102 in a trial and error manner, although adjusting the projecting location of the projection lens 102 in a trial and error manner results in much inconvenience for the user. For example, as shown in FIG. 5, the user fails in moving the center 104 from the location A to the location B within three step movements with subjective decisions in comparison to the situation shown in FIG. 4. Instead, in FIG. 5, the movement of the center 104 is composed of the vertical step movement from the location A to the location A′, the horizontal step movement from the location A′ to the location A″, the vertical step movement from the location A″ to the location B″, and the horizontal step movement from the location B″ to the location B under the trial and error manner so that such movements are time-consuming and complicated for the user. As shown in FIG. 6, after the user moves the center 104 from the location A to the location A′ vertically, the user tries to move the center 104 to a location having the same horizontal coordinate with the location B. However, since a vertical coordinate of the location A′ is restricted by the fringe of the visible region 108, the succeeding horizontal movement of the center 104 has to cross over the horizontal coordinate of the location B so that the center 104 reaches A″, and at last, when the user tries to move the center 104 vertically to reach the fringe of the visible region 108, the center 104 is moved to the location B′, which is located on the fringe of the visible region 108, instead of the ideal location B.

In summary, because movements of projection lens of a conventional projector are strongly restricted by the mechanism of the conventional projector, merely vertical movements and horizontal movements of the projection are achieved. Moreover, since the location of the center of the projection lens is also restricted by the visible region corresponding to the projection lens, mobility of the projection lens is significantly reduced, and the range of adjusting the projection lens is thus strongly restricted. Because the user has to adjust the location of the center of the projection lens in a trial and error manner, such adjustments are time-consuming and complicated, and moreover, the adjusted location of the center of the projector is far away from the ideal location of the center of the projector.

### SUMMARY OF THE INVENTION

In an embodiment of the present invention, it is disclosed for a method of calibrating a projection lens in a projector. The disclosed method comprises defining a coordinate matrix over a visible region of the projector; checking whether a coordinate of a mobile target of the projection lens is located within the visible region wherein the mobile target of the projection lens is located at the coordinate of the mobile target; and moving the projection lens to the coordinate of the mobile target when the coordinate of the mobile target is confirmed to be located within the visible region.

In an embodiment of the present invention, the disclosed method comprises defining a coordinate matrix over a visible region of the projector; and checking whether a coordinate of a mobile target of the projection lens is located within the visible region. The location of the projection lens is not calibrated when the mobile target of the projection lens is confirmed to be outside the visible region.

In an embodiment of the present invention, the disclosed method comprises defining a coordinate matrix over a visible region of the projector, calculating a second axis displacement on the basis of the calculation of inputting a first axis displacement received by the projector into a track function, and moving the projection lens to a mobile target on the basis of both the first axis displacement and the second axis displacement.

With the disclosed method of calibrating projection lens in the embodiments, a user does not have to calibrate the projection lens manually in a trial and error manner, is relieved of time-consuming and complicated moves, and is prevented from erroneous moves of the projection lens while the user knows nothing about such moves. The disclosed method in the embodiment of the claimed invention is applied to a conventional projector equipped with a projection lens capable of performing horizontal movements and vertical movements, and is applied to projectors having different geometric figures of visible regions. Therefore, applying the disclosed method on projectors having different geometric figures of visible regions should also be regarded as available embodiments of the claimed invention.

Other objectives, features and advantages of the present invention will be further understood from the further technology features disclosed by the present invention wherein there are shown and described preferred embodiments of this invention, simply by way of illustration of modes best suited to carry out the invention.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram for illustrating a projection lens of a conventional projector.

FIG. 2 schematically illustrates where the center is located corresponding to the visible region surrounded by dotted lines in the beginning in the conventional projector shown in FIG. 1.

FIG. 3 schematically illustrates an ideal condition in moving the mobile target of the center shown in FIG. 2 from a location A to a location B.

FIG. 4 schematically illustrates a practical condition in moving the mobile target of the center shown in FIG. 2 from the location A to the location B.

FIG. 5 schematically illustrates how a user moves the mobile target of the center from the location A to the location B in a trial and error manner corresponding to FIG. 3 and FIG. 4.

FIG. 6 schematically illustrates a difference between the location B and a practical location B′ in moving the mobile target of the center corresponding to FIG. 3 and FIG. 4.

FIG. 7 is a flowchart of a disclosed method of calibrating projection lens in a projector according to a preferred embodiment of the present invention.

FIG. 8, FIG. 9, FIG. 10, FIG. 11, and FIG. 12 schematically illustrate testing a defined coordinate matrix covering the visible region of the projector according to a preferred embodiment of the present invention.

FIG. 13 schematically illustrates a condition while a next succeeding coordinate of the mobile target of the center is located within the visible region in performing both Step 706 and Step 708 shown in FIG. 7.

FIG. 14 schematically illustrates a condition while the next succeeding coordinate of the mobile target of the center is located outside the visible region in performing both Step 706 and Step 710 shown in FIG. 7.

### DETAILED DESCRIPTION

It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

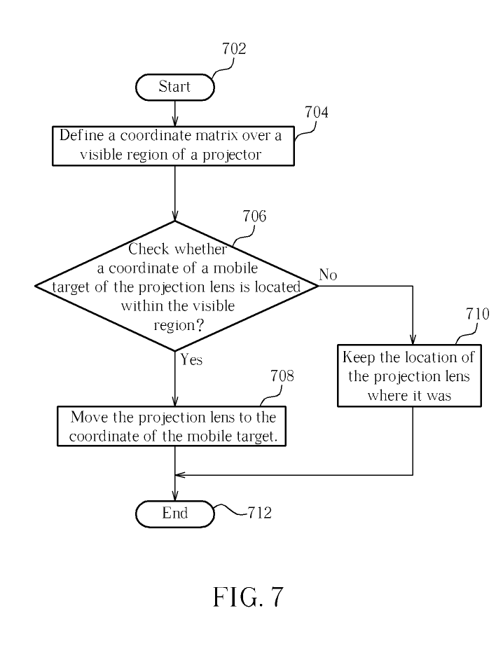

As shown in FIG. 7, a disclosed method of calibrating projection lens in a preferred embodiment of the present invention includes steps as follows:

Step 702: Start.

Step 704: Define a coordinate matrix over a visible region of a projector.

Step 706: Check whether a coordinate of a mobile target of the projection lens is located within the visible region. When the mobile target of the projection lens is checked to be located within the visible region, go to Step 708. Otherwise, go to Step 710.

Step 708: Move the projection lens to the coordinate of the mobile target.

Step 710: Keep the location of the projection lens where it was.

Step 712: End.

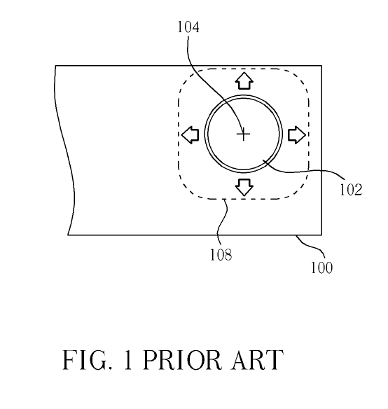

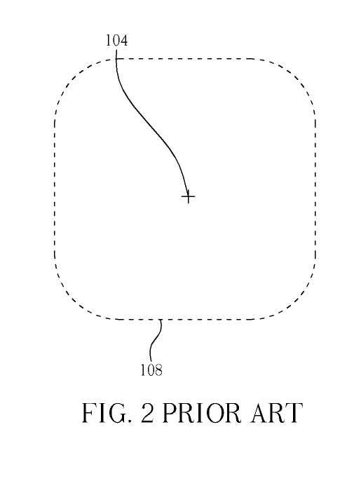

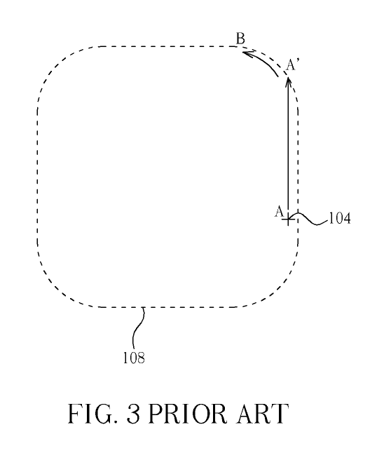

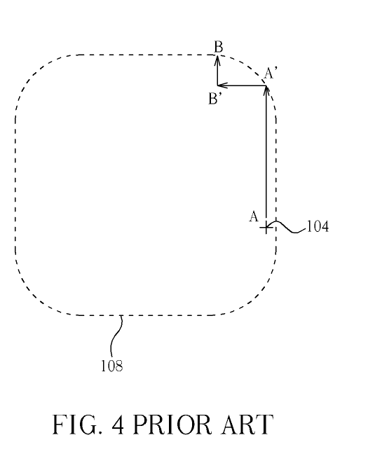

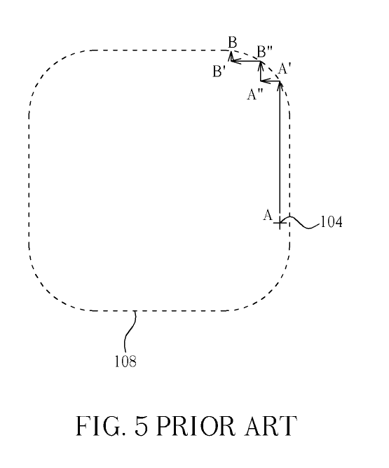

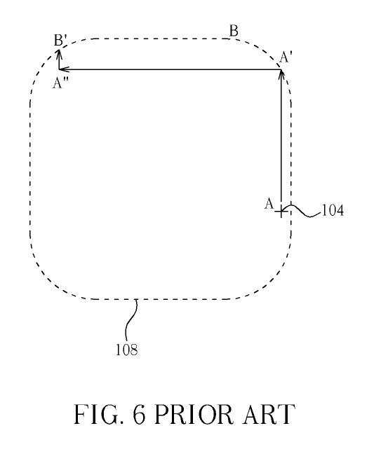

Note that the method shown in FIG. 7 may be applied to the projector 100 shown in FIG. 1. Therefore, the following descriptions about the method shown in FIG. 7 are based on the elements of the projector 100 shown in FIG. 1. First, in Step 704, a coordinate matrix is defined to include a plurality of coordinates covered by the visible region 108 of the projector 100. Then the included coordinates of the defined coordinate matrix are recorded in a built-in firmware, which is not illustrated herein, of the projector 100 so as to define a moving range of the projection lens 102 for successfully forming images.

In a preferred embodiment of the present invention, before a plurality of coordinates within the coordinate matrix covering the visible region 108 is included, the center 104 of the projection lens 102 is set to locate at a geometric center of the visible region 108. In other words, with variances of geometric figures of the visible region 108, such as a round, a square, or an irregular figure, the location of the center 104 is varied according to the various locations of the geometric center of the visible region 108. Therefore, the center 104 is located at an origin among the plurality of coordinates included in the defined coordinate matrix covering the visible region 108. A step motor, which is not illustrated herein and is connected to the projection lens 102 in the projector 100, is utilized for horizontally or vertically performing step movements of the center 104 within the visible region 108 for searching for coordinates covered by the visible region 108 one by one. Within one single step movement, the step motor moves the projection lens 102 in one unit of the coordinate matrix, then a mobile target of the projection lens 102 is checked to confirm whether said mobile target is located within the visible region 108. When the mobile target is still located within the visible region 108, the current coordinate of the mobile target is included into the coordinate matrix. In a preferred embodiment of the present invention, the built-in firmware of the projector 100 sets and records the current coordinate of the mobile target of the center 104. Otherwise, when the mobile target is checked to be outside the visible region 108, the projection lens 102 is further moved toward a different direction (vertical or horizontal) for searching for other available coordinates covered by the visible region 108 until all coordinates covered by the visible region 108 are set and recorded by the built-in firmware of the projector 100. As it can be observed from the above descriptions about the disclosed method, all coordinates covered by the visible region 108, i.e., within the defined coordinate matrix, are found out in a trial and error manner in advance so that the mobile target of the center 104 does not have to be checked for confirming it is within the visible region 108 when the user calibrates the projection lens 102. In other words, according to the disclosed method, the time-consuming and complicated properties caused by calibrating projection lens 102 in a trial and error manner in the prior art are transferred to the procedure of including the coordinates covered by the visible region 108 into the defined coordinate matrix in advance so that inconvenience for the user in calibrating the projection lens is significantly reduced.

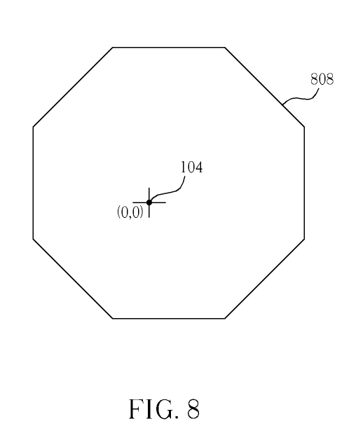

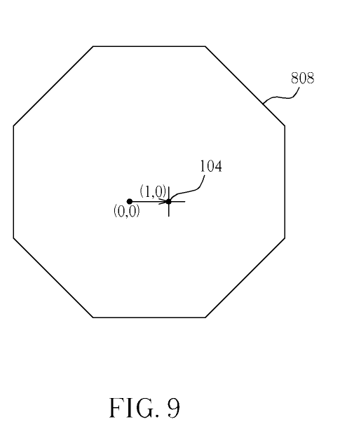

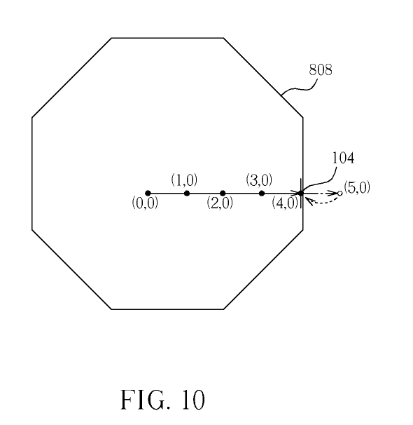

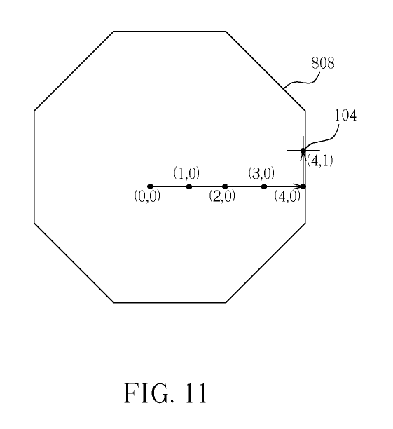

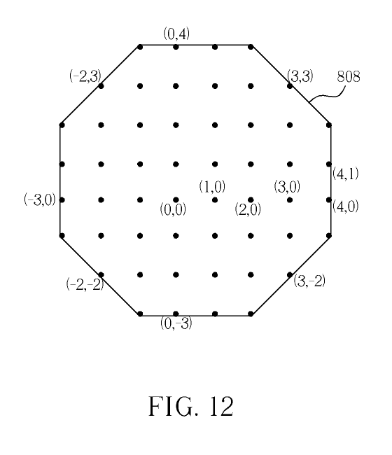

Although variances exist in geometric figures and sizes of the visible region 108 corresponding to various types of the projection lens 102, such variances may also be accommodated by confirming the geometric figure of the visible region 108 and by searching for covered coordinates within the defined coordinate matrix in a trial and error manner in advance as above-mentioned according to embodiments of the present invention. Please refer to FIG. 8, FIG. 9, FIG. 10, FIG. 11, and FIG. 12, all of which indicate a preferred embodiment of testing the visible region corresponding to the projection lens according to the method of calibrating projection lens. Note that though the illustrated geometric figure of a visible region 808 herein is an octagon from FIG. 8 to FIG. 12, other available geometric figures of the visible region may also be accommodated in other embodiments of the present invention. While the step of searching for coordinates covered by the visible region 808 begins, the center 104 has to be located as shown in FIG. 8, i.e., the geometric center of the octagon-shaped visible region 808, and the current coordinate of the center 104 is then defined as (0,0) and recorded in the built-in firmware of the projector 100. Note that at this time, the location of the defined coordinate (0,0) is a little away from the practical location of the geometric center of the octagon-shaped visible region 808 with a tiny distance so as to have the coordinates illustrated in FIG. 10, FIG. 11, and FIG. 12 precisely lie on the fringes of the octagon-shaped visible region 808. For easily describing the disclosed method from FIG. 8 to FIG. 12, all the illustrated coordinates are assumed to acquire integer elements. In FIG. 9, the step motor moves the projection lens 102 with a rightward step movement so that the center 104 is rightward moved from the coordinate (0,0) with one unit on the defined coordinate matrix. Then whether a current location of the mobile target of the center 104 is located within the visible region 808 is confirmed according to whether images of the projection lens 102 are formed at this time. When the current location of the mobile target of the center 104 is confirmed to be within the visible region 808, the built-in firmware of the projector 100 sets and records the current location of the mobile target of the center with a coordinate (1,0) as shown in FIG. 9. In FIG. 10, after the four step movements are performed as shown in FIG. 8, the built-in firmware of the projector 100 records coordinates including (0,0), (1,0), (2,0), (3,0), and (4,0), and a current location of the mobile target of the center 104 is located at the coordinate (4,0). At this time, the projector 100 is not aware of the fact that the mobile target of the center 104 has reached a fringe of the visible region 808, and activates another rightward step movement on the center 104 so that the center 104 is then temporarily moved to the dotted line node as shown in FIG. 10, i.e., a location corresponding to a coordinate (5,0) of the defined coordinate matrix if the location does not fall outside the visible region 808. After the projector 100 detects the fact that images of the projection lens 102 cannot be formed with the current location of the mobile target of the center 104, it is confirmed that the current location of the mobile target of the center 104 falls outside the visible region 808, i.e., the coordinate (5,0) does not lie within the visible region 808 so that the coordinate (5,0) is not included in the defined coordinate matrix. Therefore, the mobile target of the center 104 is immediately moved back to a next preceding coordinate, i.e. the coordinate (4,0), which still falls within the visible region 808, and the built-in firmware of the projector 100 is immediately informed with such a situation. In FIG. 11, since the projector 100 is informed with the fact that further rightward step movements of the center 104 located at the coordinate (4,0) would have the mobile target of the center 104 fall outside the visible region 808, the projector 100 tries vertical step movements on the mobile target of the center 104 from the coordinate (4,0) in FIG. 11. After the projector 100 confirms the fact that images of the projection lens 102 are successfully formed with the current location of the mobile target of the center 104, the built-in firmware of the projector 100 sets the current location of said mobile target as a coordinate (4,1) and records the set coordinate. With the step-by-step step movements in searching for available coordinates covered by the visible region 808 from FIG. 8 to FIG. 11, at last, all coordinates covered by the visible region 808 are found out and recorded in the built-in firmware of the projector 100, as shown in FIG. 12 so that rigid references in calibrating the projection lens are thus established.

Step 706 indicates the beginning of the user in calibrating the projection lens 102 for calibrating the location of the mobile target of the center 104. When the disclosed method is applied to the projector 100, a simplified user interface is provided for enabling the user to calibrate the projection lens 102. At least four direction buttons are disposed on the user interface for performing vertically upward step movements, vertically downward step movements, horizontally rightward step movements, and horizontally leftward step movements, as shown in FIG. 1, for calibrating the location of the mobile target of the center 104. Besides, a plurality of track functions is also provided through the user interface so that the user may pick up one from the plurality of track functions to calculate a next succeeding coordinate of the mobile target of the center 104. When the user activates one of the above-listed direction buttons on the user interface, a vertical or horizontal movement corresponding to the direction of the activated button is generated on the mobile target of the center 104. In detail, a next succeeding coordinate of the mobile target of the center 104 is determined according to a first axis displacement of the mobile target, a second axis displacement of the mobile target, and a track function. The first axis displacement is received by a sensor (not shown) of the projector 100, and indicates a horizontal displacement of the mobile target of the center 104 in the current embodiment of the present invention. The second axis displacement of the mobile target of the center 104 is calculated by inputting the first axis displacement into the track function, and indicates a vertical displacement of the mobile target in the current embodiment of the present invention. Then the center 104 of the projection lens 102 is moved to the calculated next succeeding coordinate of the mobile target according to both the first axis displacement and the second axis displacement. In other words, after the user activates a direction button, the built-in firmware of the projector 100 calculates the next succeeding coordinate of the mobile target of the center 104 in advance according to both the activated direction button and a set track function, and compares said next succeeding coordinate of the mobile target with all included coordinates of the defined coordinate matrix, i.e., all coordinates covered by the visible region 808 so as to confirm whether said next succeeding coordinate of the mobile target has been included in the defined coordinate matrix, i.e., whether said next succeeding coordinate is located within the visible region 808. As described in Step 708 and Step 710, when the next succeeding coordinate of the mobile target is confirmed to be located within the visible region 808, the step motor of the projector 100 immediately moves the center 104 to said next succeeding coordinate of the mobile target. Otherwise, when the next succeeding coordinate of the mobile target is located outside the visible region 808, the step motor of the projector 100 does not move the center 104, and the projector 100 issues a message to inform the user of the situation that the activated button would make the next succeeding coordinate of the mobile target be outside of the visible region 808.

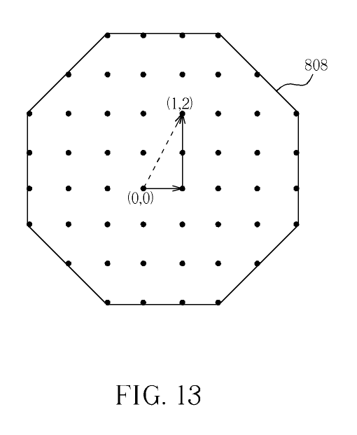

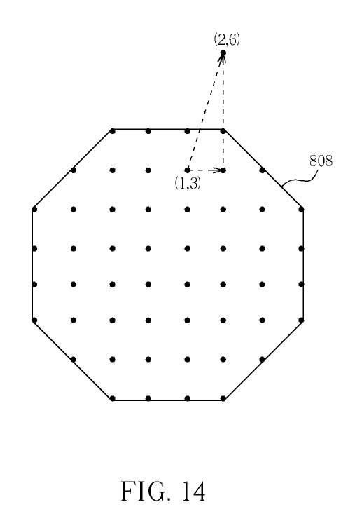

Step 706, Step 708, and Step 710 are further described as follows according to both FIG. 13 and FIG. 14. In FIG. 13, the coordinate of the center 104 is supposed to be (0,0) at the beginning, and a chosen track function is y=2x, where y indicates a vertical displacement of the mobile target of the center 104, x indicates a horizontal displacement of the mobile target of the center 104. When the user activates a direction button on the user interface for activating a rightward step movement of the mobile target, a corresponding horizontal displacement is +1, i.e., the value of the variable x is increased by 1. According to the chosen track function y=2x, the value of the variable y is thus increased by 2, i.e., a corresponding vertical displacement of the mobile target of the center 104 is +2. As a result, the next succeeding coordinate of the mobile target of the center 104 is thus (1,2). At this time, the built-in firmware of the projector 100 compares the next succeeding coordinate (1,2) of the mobile target with all included coordinates of the defined coordinate matrix related to the visible region 808, and then the next succeeding coordinate (1,2) of the mobile target is confirmed to be located within the visible region 808. Therefore, according to the result of the confirmation, the step motor of the projector 100 moves the center 104 with one horizontal step movements and two vertical step movements, as shown with both the continuous arrows in FIG. 13. Note that the dotted arrow shown in FIG. 13 indicates a supposed track of the mobile target of the center 104.

In FIG. 14, the coordinate of the mobile target of the center 104 is supposed to be (1,3) at the beginning, and the chosen track function is y=3×, where definitions of both the variables x and y are the same as the above descriptions. When the user activates a direction button on the user interface for activating a rightward step movement of the mobile target of the center 104, the value of a corresponding horizontal displacement of the mobile target of the center 104 is +1. According to the chosen track function y=3×, a corresponding vertical displacement of the mobile target of the center 104 is +3 so that a next succeeding coordinate of the mobile target of the center 104 is (2,6). The built-in firmware of the projector 100 then compares the next succeeding coordinate (2,6) of the mobile target with all included coordinates in the coordinate matrix related to the visible region 808, and confirms the fact that the next succeeding coordinate (2,6) of the mobile target is not included in the coordinate matrix, i.e., the next succeeding coordinate (2,6) is not located within the visible region 808. Therefore, the step motor of the projector 100 does not move the mobile target of the center 104 to the next succeeding coordinate (2,6), and the projector 100 informs, by the user interface, the user of the above-mentioned fact that the mobile target of the center 104 will move out of the visible region 808. The dotted arrows shown in FIG. 14 indicate a supposed track of the mobile target of the center 104, and the mobile target of the center 104 is actually not moved along the supposed track.

Note that though track functions described in FIG. 13 and FIG. 14 are linear, in other available embodiments of the present invention, multi-dimensional track functions may still be used, and should be included in the scope of the present invention.

With the disclosed method of calibrating projection lens, a user does not have to calibrate the projection lens manually in a trial and error manner, is relieved to be off from time-consuming and complicated moves, and is prevented from erroneous moves of the projection lens while the user knows nothing about such moves. The disclosed method may be applied to a conventional projector equipped with a projection lens, which is capable of performing horizontal movements and vertical movements, and may be applied to projectors having different geometric figures of visible regions. Therefore, applying the disclosed method on projectors having different geometric figures of visible regions should also be regarded as available embodiments of the present invention.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

Those skilled in the art will readily observe that numerous modifications and alterations of the device and method may be made while retaining the teachings of the invention.

What is claimed is:

1. A method of calibrating a projection lens in a projector comprising:
defining a coordinate matrix over a visible region of the projector;
checking whether a coordinate of a mobile target of the projection lens is located within the visible region wherein the mobile target of the projection lens is located at the coordinate of the mobile target; and
moving the projection lens to the coordinate of the mobile target when the coordinate of the mobile target is confirmed to be located within the visible region.

2. The method of claim 1 wherein the coordinate of the mobile target is generated by calculating a second axis displacement on the basis of the calculation of inputting a first axis displacement received by the projector into a track function.

3. The method of claim 2 wherein the track function for calculating the coordinate of the mobile target of the projector lens is selected from a plurality of track functions.

4. The method of claim 1 wherein the projection lens is not calibrated when the coordinate of the mobile target is confirmed to be located outside the visible region.

5. The method of claim 1 wherein defining the coordinate matrix over the visible region of the projector comprises:
positioning the projection lens at a center of the visible region; and
using a motor to perform step movements on the projection lens for locating coordinates of the coordinate matrix within the visible region one by one;
wherein the motor drives the projection lens to move one unit in the coordinate matrix, and checks whether the mobile target of the projection lens is located within the visible region, in a performed step movement.

6. The method of claim 5 wherein using the motor to perform step movements on the projection lens for locating the coordinates of the coordinate matrix within the visible region one by one comprises:
adding the coordinate of the mobile target into the coordinate matrix in the performed step movement when the mobile target is located within the visible region.

7. The method of claim 5 wherein using the motor to perform step movements on the projection lens for locating the coordinates of the coordinate matrix within the visible region one by one comprises:
moving the projection lens with various directions for keeping on locating another available coordinate within the coordinate matrix of the visible region in the performed step movement when the mobile target of the projection lens is located outside the visible region.

8. A method of calibrating a projection lens in a projector comprising:
defining a coordinate matrix over a visible region of the projector; and
checking whether a coordinate of a mobile target of the projection lens is located within the visible region wherein the mobile target of the projection lens is located at the coordinate of the mobile target;
wherein the location of the projection lens is not calibrated when the mobile target of the projection lens is confirmed to be outside the visible region.

9. The method of claim 8 wherein the coordinate of the mobile target is generated by calculating a second axis displacement on the basis of the calculation of inputting a first axis displacement received by the projector into a track function.

10. The method of claim 8 wherein defining the coordinate matrix over the visible region of the projector comprises:
positioning the projection lens at the center of the visible region; and
using a motor to perform step movements on the projection lens for locating coordinates of the coordinate matrix within the visible region one by one;
wherein the motor drives the projection lens to move one unit in the coordinate matrix, and checks whether the mobile target of the projection lens is located within the visible region, in a performed step movement.

11. The method of claim 10 wherein using the motor to perform the step movements for locating the coordinates of the coordinate matrix within the visible region one by one comprises:
adding the coordinate of the mobile target into the coordinate matrix in the performed step movement when the mobile target is located within the visible region.

12. The method of claim 10 wherein using the motor to perform step movements on the projection lens for locating the coordinates of the coordinate matrix within the visible region one by one comprises:
moving the projection lens with various directions for keeping on locating another available coordinate within the coordinate matrix of the visible region in the performed step movement when the mobile target of the projection lens is located outside the visible region.

13. A method of calibrating a projection lens in a projector comprising:
defining a coordinate matrix over a visible region of the projector;
calculating a second axis displacement on the basis of the calculation of inputting a first axis displacement received by the projector into a track function; and
moving the projection lens to a mobile target on the basis of the first axis displacement and the second axis displacement.

14. The method of claim 13 wherein defining the coordinate matrix over the visible region of the projector comprises:
positioning the projection lens at a center of the visible region; and
using a motor to perform step movements on the projection lens for locating coordinates of the coordinate matrix within the visible region one by one;
wherein the motor drives the projection lens to move one unit in the coordinate matrix, and checks whether the mobile target of the projection lens is located within the visible region, in a performed step movement.

15. The method of claim 14 wherein using the motor to perform step movements on the projection lens for locating the coordinates of the coordinate matrix within the visible region one by one comprises:
adding the coordinate of the mobile target into the coordinate matrix in the performed step movement when the mobile target is located within the visible region.

16. The method of claim 14 wherein using the motor to perform step movements on the projection lens for locating the coordinates of the coordinate matrix within the visible region one by one comprises:
moving the projection lens in various directions for keeping on locating another available coordinate within the coordinate matrix of the visible region in the performed step movement when the mobile target of the projection lens is located outside the visible region.

17. The method of claim 13 wherein the track function for calculating the second axis displacement is selected from a plurality of track functions.

18. The method of claim 13 further comprising:
checking whether a coordinate of the mobile target of the projection lens is located within the visible region wherein the mobile target of the projection lens is located at the coordinate of the mobile target; and
moving the projection lens to the coordinate of the mobile target when the coordinate of the mobile target is confirmed to be located within the visible region.

19. The method of claim 13 further comprising:
checking whether a coordinate of a mobile target a projection lens is located within the visible region wherein the mobile target of the projection lens is located at the coordinate of the mobile target;
wherein the location of the projection lens is not calibrated when the mobile target of the projection lens is confirmed to be outside the visible region.
